(19) United States
(12) Patent Application Publication
(10) Pub. No.: US 2008/0281572 A1
(43) Pub. Date: Nov. 13, 2008

(54) INTEGRATED CIRCUIT (IC) DESIGN METHOD AND METHOD OF ANALYZING RADIATION-INDUCED SINGLE-EVENT UPSETS IN CMOS LOGIC DESIGNS

(76) Inventors: Ruchir Puri, Bladwin Place, NY (US); Henry H. K. Tang, Poughkeepsie, NY (US); Kim Yaw Tong, Austin, TX (US)

Correspondence Address: LAW OFFICE OF CHARLES W. PETERSON, JR. Yorktown, 435B Carlisle Dr., Herndon, VA, 20170, US

(21) Appl. No.: 11/746,709

(22) Filed: May 10, 2007

(51) Int. Cl. G06F 17/50

(52) U.S. Cl. 703/16

(57) ABSTRACT

A logic design tool, a tool for analyzing soft error sensitivities in logic, and a program product for logic design. A particle generator simulates events likely to occur for a given operating environment. A pre-characterizer provides circuit block responses to simulated events. A circuit response simulator simulates events in a logic design and provides an indication of soft error sensitivity for the design. Based on the soft error sensitivity indication, the design may be modified to reduce the overall soft error sensitivity.

### BACKGROUND OF THE INVENTION

1. Field of the Invention

The present invention is related to Integrated Circuit (IC) chip design and more particularly to designing IC logic chips that have Single-Event Upset (SEU) tolerant circuits and have a low Soft-Error Rate (SER).

2. Background Description

Transitory, non-repeatable Integrated Circuit (IC) malfunctions are well known in the art as soft errors or Single-Event Upsets (SEUs). Transient ionizing particles passing through a semiconductor creates local electron-hole pairs along its path of travel. If a particle passes with enough energy and close enough to a circuit node, e.g., the source/drain of a Field Effect Transistor (FET) or device, charge from the localized electron-hole pairs can create transient current in the node. Frequently, the current can partially or completely charge/discharge a discharged/charged node at least temporarily. Unintentionally fully charging/discharging the circuit node can cause a sensitive circuit to change states, i.e., the circuit is upset. Consequently, since the failure is not permanent and unrepeatable, the circuit fails in an unrepeatable way in what is known as a soft failure or a soft error. A soft error in a Random Access Memory (RAM) occurs, for example, when a soft error source upsets a single random cell in the RAM array, switching the cell's state. The SEU upset frequency for an IC is the Soft-Error Rate (SER) of the IC. So, SER is a sensitivity measure of an IC's susceptibility to SEUs. SER is also a metric to guide circuit designers and, especially for evaluating the robustness of a circuit.

In the insulated gate technology commonly referred to as CMOS, alpha particles (⁴He nuclei) emitted from traces of radioactive elements in packaging materials and nuclear spallation products produced by high-energy neutrons from cosmic ray background are two major Earth-bound ionizing particle sources. In space programs, CMOS devices and circuits are constantly exposed to background high-energy cosmic ray particles like protons and heavy ions—particles which are ionizing and which also induce secondary charged particles by nuclear reactions. Dynamic RAMs (DRAMs) storing memory contents on a relatively small capacitor, for example, have long been known to be very sensitive to alpha particles. Since alpha particles are relatively easy to shield, it has been found that some IC materials are alpha particle emitters. Locally originating alpha particles, typically, have low energy, e.g., a few million or Mega electron Volts (MeVs). For example, an alpha particle from a polonium (²¹⁰Po) source has an energy of 5.3 MeV. Normally, these low energy alpha particles have not generated enough charge to upset older technology logic.

A soft error in random logic occurs when a soft error source causes a transient logic state change that is latched and/or ripples forward through subsequent logic from the upset. Traditionally, most of the SEU focus has been directed to storage elements, such as memory arrays and latches. Especially in older technologies, storage elements have proven more susceptible to SEUs than combinational logic. Since the discharge effects of ionizing particles striking near combinational IC logic has been, more or less, unnoticeable, logic circuit susceptibility to SEU, largely, has been ignored. However, high-energy neutrons, primarily from cosmic rays, have typical energies that range from hundreds of MeVs to billions or Giga electron Volts (GeVs). Similarly, in space-based applications, and even in high-altitude flights, high-energy protons and charged pions have caused SEUs.

Consequently, with decreasing device feature sizes and increasing clock speeds, IC logic has become increasingly sensitive to SEU, especially from these high energy particles. Moreover, as chip features have shrunk from the sub-micron into nanometer range, circuits have become much more sensitive and require dramatically less charge to upset. Further, higher performance, more responsive logic operating at ever increasing clock speeds, has increased significantly the probability that a combinational logic upset will propagate and eventually be registered in a storage element. Recently, for example, low energy and thermal neutrons have caused SEUs in commercial and state of the art ICs. Consequently, this increased combinational logic sensitivity has meant that SEUs have become a significant IC reliability threat. However, an accurate and efficient SER estimation is an essential requirement for addressing the threat from SEUs.

Generally, current SER estimation has been either very fine, focused at device level or, very coarse focused at overall chip level. Detailed device level SER modeling considers localized complex atomic and nuclear interactions for single device (or a few devices). Coarser state of the art circuit and architectural level analysis approaches have adopted grossly simplified physical models to develop a crude overall SER. Neither of these approaches links fundamental device level physics with the more abstract, higher circuit level or chip analysis. Since typical circuit analysis for such complex ICs is very complex, any circuit level analysis is computer resource intensive. Moreover, circuit level SER analysis has been infeasible using existing state of the art models. Existing detailed physics-based analyses further burden computer resources, making SER analysis computationally infeasible. There is a lack of accurate physics-based analytical models for modeling circuit responses to particle strikes.

Thus, there is a need for accurate SER circuit models for analyzing complex SEU issues in combinational logic and determining SEU sensitivities in highly complexity of modern day ICs; and especially, for performing circuit-specific SEU analysis that accurately captures electrical properties of each gate in an IC design, logical masking effects on each gate, and storage element latching windows.

### SUMMARY OF THE INVENTION

It is a purpose of the invention to reduce soft errors in CMOS logic circuits;

It is another purpose of the invention to provide an indication of soft error sensitivities in logic circuit designs;

It is yet another purpose of the invention to reduce computer resources required to quantify soft error sensitivities in logic circuit designs;

It is yet another purpose of the invention to provide logic circuit designers with provide an indication of soft error sensitivities in logic circuit designs, while reduce computer resources required to quantify soft error sensitivities.

The present invention is related to a logic design tool, a tool for analyzing soft error sensitivities in logic, and a program product for logic design. A particle generator simulates events likely to occur for a given operating environment. A pre-characterizer provides circuit block responses to simulated events. A circuit response simulator simulates events in a logic design and provides an indication of soft error sensitivity for the design. Based on the soft error sensitivity indication, the design may be modified to reduce the overall soft error sensitivity.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an overview example of a preferred embodiment tool for analyzing logic for single event upsets (SEU) according to the present invention;

FIG. 2 shows an example of three dimensional (3D) schematic example diagramming production of secondary particles induced by a neutron-nucleus reaction in a typical collision event;

FIG. 3 shows an overview of SEU logic circuit analysis engine for fundamental physics-based simulation of radiation sources;

FIG. 4 shows a flow diagram example in more detail of particle path analysis for obtaining a probability distribution of device responses to various particles;

FIG. 5 shows a 3D schematic example diagramming a charged particle hitting the surface of the Si layer or device region for quantifying effective LET;

FIG. 6 shows a 3D schematic example diagram of a device model for SEU/SER analysis in fast transient simulation;

FIG. 7A shows a schematic example of an inverter for AC or transient pre-characterization in circuit response pre-characterization;

FIG. 7B shows a representative example of a time-varying current pulse modeled from an ionizing particle for pre-characterizing standard cells;

FIG. 8 shows a simple example of DC or static pre-characterization to obtain current for all bias conditions of interest on a typical standard cell in circuit response pre-characterization;

FIG. 9 shows a program flow example of event generation and pulse propagation simulation to iteratively generate a soft error rate for each logic block or cell in the standard cell library;

FIG. 10 shows a timing example showing an event in a latching window for timing derating.

### DESCRIPTION OF PREFERRED EMBODIMENTS

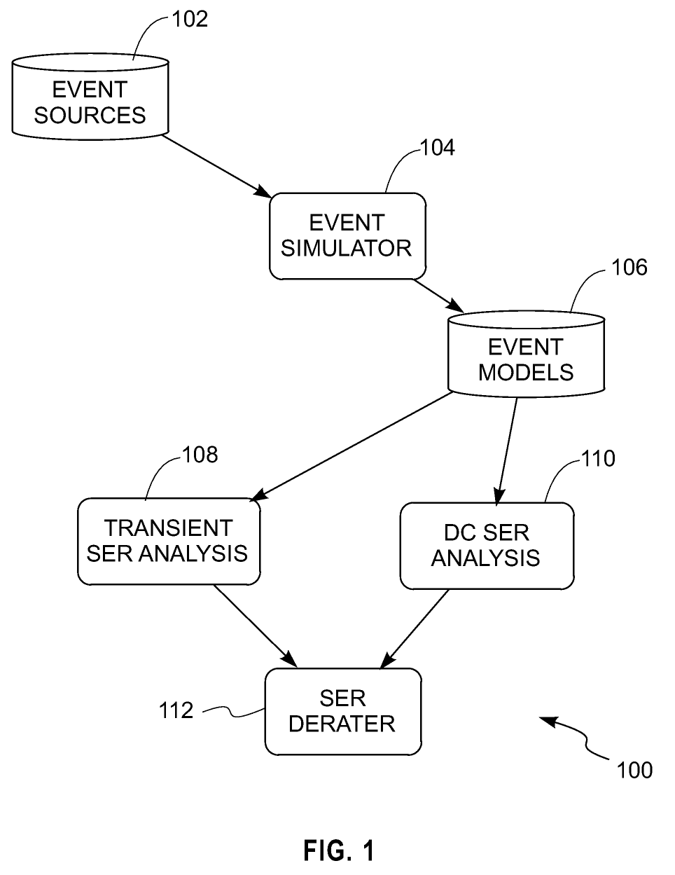

Turning now to the drawings, and more particularly, FIG. 1 shows an overview example of a preferred embodiment tool 100 for analyzing logic for Single Event Upsets (SEUs), logic Soft Errors Analysis Tool (logicSEAT), according to the present invention. In particular, the preferred SEU analysis tool 100 facilitates very accurate combinational logic Soft Error Rate (SER) estimates for logic in the insulated gate technology commonly referred to as CMOS. The preferred SEU analysis tool 100 provides estimates based on technology-mapped netlists, with computer resources minimized for the analysis. Furthermore, although described herein with reference to SER analysis of CMOS circuits and CMOS Integrated Circuit (IC) chips, this is for example only and not intended as a limitation. The present invention has application to reducing analysis requirements for any circuit where soft errors are a concern.

Particle flux information is derived from nuclear databases and reaction models and stored 102. Event particles are simulated 104 to generate a radiation field from, and to create a closed-form current pulse model 106 for, each event. Each current pulse model 106 models a device response to a particle strike. Book responses for each book or cell in a standard cell library are simulated, providing both transient SER analysis 108 and static SER analysis 110 for each particle strike or event. During simulation arbitrary technology-mapped book netlists are analyzed for accurate transient simulation. Further, these gate simulations 108, 110 facilitate efficient gate level design for combinational logic in IC chip designs. In addition, for static analysis logical masking and latching window effects are accurately estimated and derated 112. In short, logicSEAT efficiently relates physics-based device responses to gate level SER analysis for fast and efficient higher level logic analysis, even at chip level. Thus, when applied to higher level logic, e.g., a macro or IC chip constructed from standard cells, chip SER may be determined 114 and, if necessary (e.g., because the macro/chip SER is too high), modified or redesigned 116.

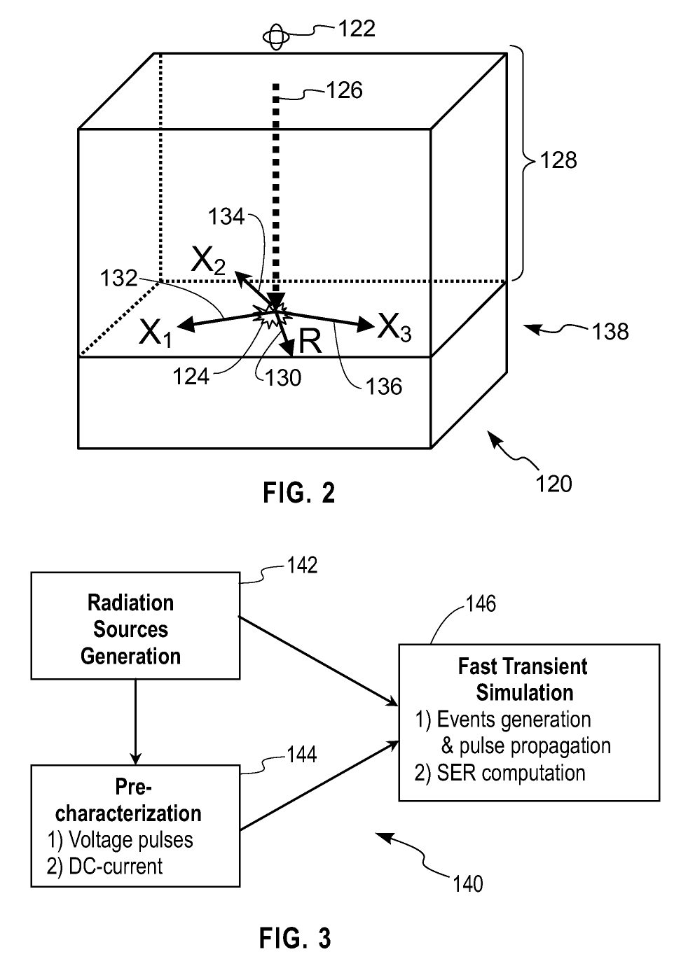

FIG. 2 shows a three dimensional (3D) schematic example 120 diagramming a typical neutron-nucleus collision event, e.g., from a cosmic neutron 122. Cosmic rays have sufficient energy that an electrically neutral particle, such as a high energy neutron 122 collides with a nucleus 124 along its path 126, the collision initiates some nuclear reaction. Modeling the SEU effects of a particle 122 requires following the transport path 126 of the particle 122, e.g., through a chip. In this example, the incident neutron 122 traverses a certain distance through upper chip layers (i.e., Back End of the Line (BEOL) materials) 128 to collide with the nucleus 124, initiating a local nuclear reaction with the nucleus 124. Accurate analysis requires computing the energy loss in the BEOL layers 128 to determine the particle energy as it collides with nucleus 124.

Generally, a nuclear reaction from a collision results in scattering that may be characterized as elastic, where the particle (normally a low energy particle) is deflected; and, inelastic, where the target atom fragments (from a collision with a high energy particle) into what are referred to as secondary particles 130, 132, 134, 136. Elastic scattering results when the particle (e.g., an alpha particle) is deflected slightly from its original path. The target nucleus (i.e., any atom in the volume material, e.g., Si, O, N, or Cu) also recoils with some energy level and ionizes surrounding material. If this ionization is near enough to a sensitive node or sensitive device region, an SEU may occur. In this particular example of FIG. 2, inelastic collision produces secondary particles that include a recoil nucleus (vector R) 130 and three fragments, 132, 134, 136, vectors X₁, X₂ and X₃, respectively. Typically, secondary fragments produced in an inelastic collision include a heavy recoil nucleus such as Mg, O, or C, and/or lighter particles such as protons, deuterons, tritons, or He.

A typical recoil nucleus 130 may be any nucleus lighter than the original target nucleus. The three lighter fragments 132, 134, 136 are light ions such as a proton, a deuteron, a triton, a helium (He) ion, or a lithium (Li) ion. These secondary particles 130, 132, 134, 136 usually carry large kinetic energies in the MeV range, and are themselves particles that can continue traveling for a relatively long distance through the structure 120. So, a fragment that reaches the underlying semiconductor, e.g., silicon (Si) layer 138 or, even active device region (not shown in this example) may cause an upset in a circuit. Previously, a detailed fundamental physics of such a strike is otherwise prohibitively expensive and computationally unfeasible, especially with respect to circuit and/or architectural level analysis.

FIG. 3 shows an overview of SEU logic circuit analysis engine 140 for fundamental physics-based simulation of radiation sources according to a preferred embodiment of the present invention. Essentially, logic circuit analysis engine 140 includes a three pronged approach of particle path analysis 142, circuit response pre-characterization 144 and event fast transient response analysis 146.

In particle path analysis 142 ionizing particle descriptions are generated with projected paths through the IC. These particle descriptions and projected paths may be generated, for example, using Monte Carlo techniques based on data in nuclear databases and reaction models. Ionizing particle descriptions and paths may be used in both pre-characterization 144 and fast transient response analysis 146, e.g., to simulate and characterize device responses. Preferably, radiation fields are created for a given particle distribution (e.g., particle source, angle of incidence and energy), to simulate particle responses and project particle paths, e.g., particle energy loss through the BEOL material layers. Collisions are simulated as impulse driven, exponentially decaying current pulses of varying pulse width (i.e., varying decay coefficient) and magnitude. The simulation generates an event probability distribution point for each event with the final result providing a tabular device response distribution with respect to particle strikes. So, particle strikes represented as current pulses are applied in a physics-based analytical model to directly derive a device response distribution from the projected radiation event distribution from particle path analysis 142. Circuit response pre-characterization 144 is based on these accurate physical device models.

Preferably, the entire standard cell library is pre-characterized 144 to relate gate level simulations to these physical models. This pre-characterization may be done using transistor level SPICE simulations to simulate the response of each gate to the current pulses. These gate responses are time-domain voltage pulses at the output of each respective standard cell. The resulting voltage pulses characterize each standard cell with respect to a radiation event source at a given load capacitance for the respective cell. The voltage pulses and other data are stored for later use during fast transient simulation 146. Pre-characterization also generates DC-current responses of each cell under various bias conditions for each standard cell in the standard cell library. This is also stored for subsequent use in the fast transient simulation 146.

In fast transient response analysis 146, circuit responses to radiation events are generated for events occurring at various nodes in a given circuit in the standard cell library. However, instead of a full blown transient analysis for the entire circuit response to each event, only the voltage response of the affected standard cell book, the book hit by the event causing particle, is retrieved in a table-lookup from the pre-characterized voltage pulse responses. This response is propagated forward through the fan-out cone of the book, i.e., through those downstream books that a signal originating at the affected book normally propagates. The propagated signal terminates in a storage element or at a register or a latch. This fan-out cone and propagation is determined by application of the pre-characterized transient and DC-current data. An SEU is taken to occur only occurs when a pulse propagating through a fan-out cone reaches a storage element (an event-sink) with sufficient time to latch in that storage element. So, for example, an event in pipelined logic must be sufficient to satisfy the set up and hold time requirements for terminating pipeline register.

Thus, the probability of an SEU is derated for a number of factors besides the probability of the radiation event. The resulting pulse amplitude and width must be sufficient. The pulse signal must propagate from the event-source to event-sink. The physical dimensions of the book and IC itself also determine the probability of the radiation event, i.e., the smaller the book on a larger IC, the lower the probability of being hit by a particle. Unlike prior approaches to determining the overall SER by summing the SEU probability from all radiation events, a preferred logic analysis approach considers the effects of electrical attenuation, latching windows, and logical masking at an unprecedented degree with corresponding unprecedented accuracy at a very fast runtime.

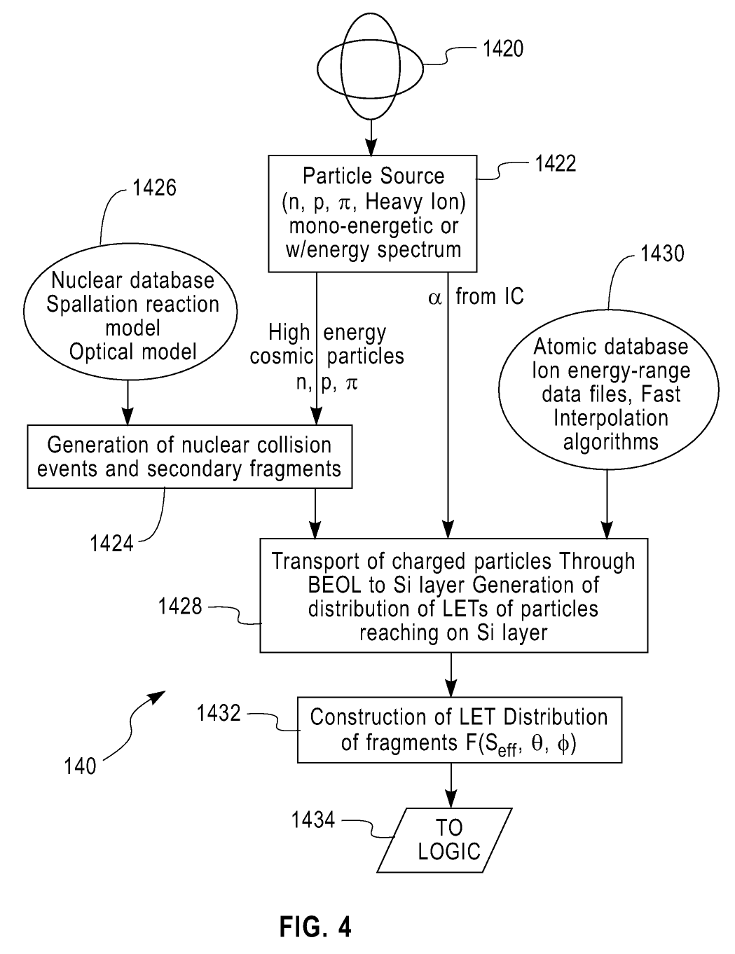

FIG. 4 shows a flow diagram example in more detail of particle path analysis 142 for obtaining a probability distribution of device responses to various particles. In step 1420 a source particle is selected, e.g., an alpha particle, a heavy ion, or cosmic ray particle. In step 1422, the selected particle is either a high-energy particle (e.g., a cosmic ray particle) or a low energy particle, e.g., a locally generated alpha particle. If the particle is a high-energy particle, then a high energy collision is simulated in step 1424 based on available stored data and collision models in particle characteristic storage 1426. If the particle is a low-energy particle or, after simulating the high energy collision, the particle passes through the chip (e.g., vertically through BEOL layers and/or as laterally radiating fragments from an inelastic collision) to a target location in step 1428, where electron-hole pairs are generated. Impact storage 1430 includes and atomic database with particle specific electron-hole pair characterization for generating electron-holes pairs, e.g., using fast interpolation. In step 1432 an effective linear energy transfer (LET), the energy loss per unit track length of an ion in a medium, is determined for each charged fragment that successfully passes through to impact. Finally, in step 1434, the result is provided, e.g., stored and subsequently used, for circuit simulation.

So, as noted hereinabove a source particle is selected in step 1420 may be a low energy particle such as, an alpha particle, a high energy heavy ion, or cosmic ray particle, e.g., a neutron, a proton, or a charged pion. Although the discussion of the present invention is directed to mono-energetic particle sources, this is for simplicity of discussion only and not intended as a limitation. It is understood, however, that the present invention has application to particles having any energy distribution, such as cosmic neutrons with a defined energy spectrum.

For higher energy cosmic ray particles (neutron, proton, or pion), a nuclear collision point is constructed in step 1424. Collision simulation 1424 also requires certain nuclear cross section parameters (elastic and inelastic, or reaction, cross sections) that are provided in the nuclear database from particle characteristic storage 1426. Preferably, these parameters are generated by modeling a sufficient number of suitable nuclear reactions using typical state of the art nuclear reaction models, most preferably, a nuclear spallation reaction model combined with a nuclear optical model. Also, secondary fragments may be constructed using these nuclear models in combination with well known Monte Carlo techniques to produce an appropriate collision event. An example of a suitable nuclear spallation reaction model is NUclear SPAllation reaction (NUSPA) described in H. H. K. Tang, “Nuclear Physics Of Cosmic Ray Interaction With Semiconductor Materials—Particle-Induced Soft Errors From A Physicist's Perspective,” IBM J. Res. Dev. 40(1), 91-108 (1996), which describes the role of nuclear models in SEU simulations. See also, H. H. K. Tang et al., “Cascade Statistical Model For Nucleon-Induced Reactions On Light Nuclei In The Energy Range 50 MeV-1 GeV,” Phys. Rev. C42, 1598-1622, 1990; and, H. K. Tang et al., “SEMM-2: A Modeling System For Single-Event Upset Analysis,” Conference Proceedings of NSREC 2004. Preferably, suitable reaction models are stored with the nuclear database in particle characteristic storage 1426.

Although particle path analysis 142 for the example of FIG. 4 is described as a particle-by-particle analysis sequentially from step 1420 through step 1432 for each particle, this is for example only and for simplicity of description. Preferably, collision simulation 1424 is provided for a large number of particles that each constitute a radiation field capable of causing an SEU in the circuits. Generally, for statistical significance the number of collision events is relatively large, e.g., on the order of 1 million. Collision simulation 1424 generates an ensemble of charged fragments that hit the surface of the Si layer or device regions. The charged fragment ensemble is provided as a group for transport calculation in step 1428. It should be noted that by stockpiling collision results, the burden of large-scale simulation is reduced, dramatically, to a computationally manageable problem.

For example, neutron-silicon reactions are generated only once for subsequent storage in the nuclear database in particle characteristic storage 1426. Thereafter, rather than re-simulating and regenerating results, stored results are retrieved from the nuclear database and used or re-used for many different applications, e.g., totally unrelated IC designs. In each such application or design, generating an ensemble of several thousand events and their current/voltage pulses on a state of the art workstation typically takes only a small fraction of 1 CPU minute

Regardless, however, of whether a particle is a fragment generated from a high energy particle collision in step 1424 (e.g., cosmic rays) or a low energy particle (e.g., an alpha particle from a local radioactive source in IC materials), the particle loses energy as it passes through the upper layers of a chip. This energy loss is accounted for in detailed in transport step 1428, based on data in the atomic database stored in impact storage 1430. The impact storage 1430 also includes a description of the structure through which the particle is to traverse. Also, the impact storage 1430 includes previously determined thickness and material type for various BEOL layers, as well as, ion energy ranges of particles in these BEOL materials. A typical BEOL stack may include appropriate dielectric materials, for example, dielectric (SiO₂) and/or nitride, and wiring, e.g., copper. Again with application of efficient, accurate look-up interpolation algorithms, the energy loss of a particular ion may be determined in any layer of any particular BEOL material. Thus, any particle's trajectory may be constructed through any combination of materials in the BEOL region.

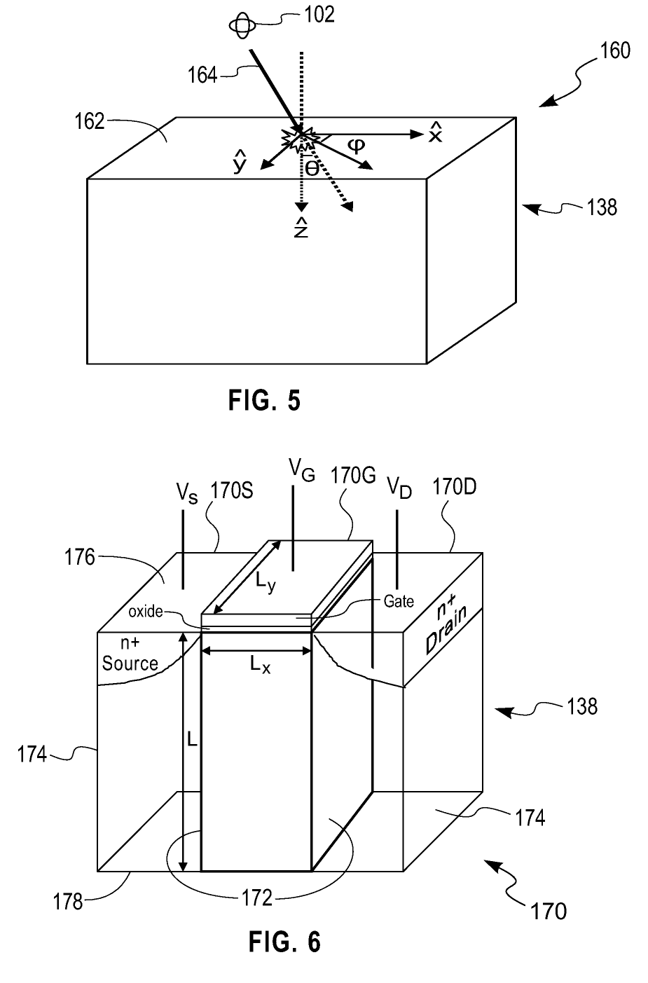

FIG. 5 shows a 3D schematic example 160 diagramming a charged particle hitting the surface 162 of the Si layer 138 or device region for quantifying effective LET in step 1432 with reference to FIG. 2. In this example the particle 102 path of travel 164 is non-orthogonal to the surface 162, with an angle θ to the Z-axis, where θ is the incident angle. Also in this example, the path of travel 164 is offset from the x axis by a polar angle φ. An effective LET (S_{eff}) is quantified for each charged fragment that hits the Si layer surface. The LET is defined as the energy loss per unit track length of an ion in a medium, i.e., S_{eff}=surface LET/cosine θ.

Multiplying the effective LET by the Si layer thickness provides the energy expended by radiation particle traversing the Si layer. Since that energy creates electron-hole pairs, this determines the deposited charge in the Si layer. In Si, for example, 33.5 femtoCoulombs (33.5 fC) of electrons and 44.5 fC of holes are generated for every 1.0 MeV of energy deposited. So, for an appropriate normalization constant N may be determined such that, N F(S_{eff};θ,φ) dS sin(θ) dθ dφ=differential probability of finding a radiation particle hitting the Si layer with effective LET in the range of (S_{eff}−dS/2,S_{eff}+dS/2), and in the angular range of (θ−dθ/2, θ+dθ/2) and (φ−dθ/2, θ+dθ/2). Thus having constructed the radiation field on the surface of the Si layer, representative inputs (i.e., of a hit) may be constructed for gate level simulation by converting the particle LET distributions into a current pulse distribution.

Prior art analysis approaches to solving the time-dependent drift-diffusion (DD) equation for a typical particle hitting the Si layer have proven inadequate, even using the above determined excess charge (electrons or holes) generated in the Si layer. If part of the ion track (i.e. the part in the Si layer) overlaps significantly with a sensitive device, the transient current induced by the ionization may be computed by solving the time-dependent drift-diffusion equation. Then, this current pulse characterizes a standard cell voltage responses to a particle strike. However, while the full time-dependent DD equation can be solved by standard device simulators, such computation is very CPU intensive and, so, impractical. Consequently, determining logic SER using these prior approaches remains highly complex for modern ICs.

By contrast FIG. 6 shows a 3D schematic example diagram of an Lₓ by L_{y} (length to width) device model 170 in a L thick silicon surface layer 138 for SEU/SER analysis in fast transient simulation (e.g., 144 in FIG. 3) according to a preferred embodiment of the present invention. The device in this example is an N-type Field Effect Transistor (NFET) with source, drain and gate bias voltages, V_{S}, V_{D}, V_{G}, connected to a source 170S, drain 170D and gate 170G, respectively. This preferred physics-based device model 170 is suitable for modeling a SEU as a simplified current pulse that does not require a large volume of numerical computation. Using typical analytic methods, e.g., Fourier analysis, events may be modeled as current pulses that are constructed from closed-form solutions of the time-dependent DD equation in Cartesian coordinates. Appropriate boundary conditions are applied to the 6 device surfaces: the channel region ends 172; insulating side walls 174; an insulating top wall 176 separating the channel from the gate oxide, and a bottom wall 178 that separates the channel from the substrate or buried oxide. Using this preferred model, closed form, time-dependent DD equation solutions may be constructed. Because the Fourier series solutions have good convergence properties, typically 30 to 50 Fourier components in each direction provide accurate solutions for 100 nm devices. Advantageously, these simulations require negligible CPU time. So, generating current pulses with this analytical model does not significantly increase the computational time.

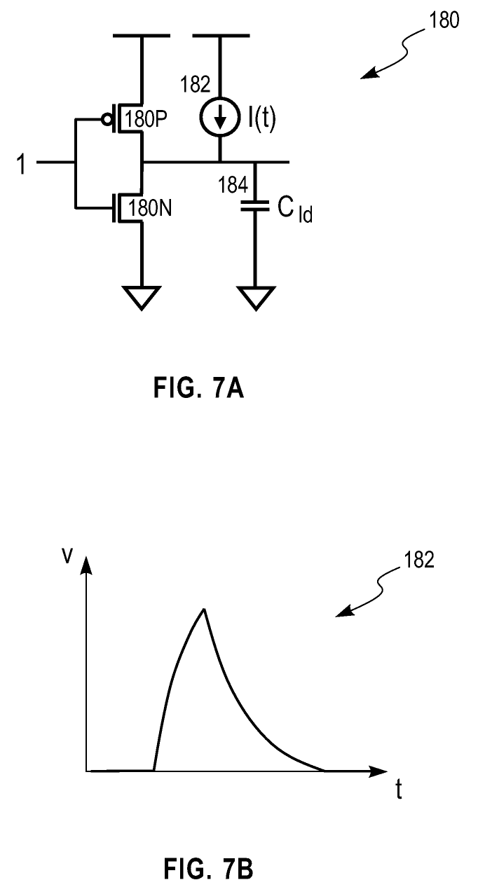

FIG. 7A shows a schematic example of an inverter 180, in this example, for AC or transient pre-characterization in circuit response pre-characterization step 144 of FIG. 3. FIG. 7B shows a representative example of a time-varying current pulse 182 modeled from an ionizing particle for pre-characterizing standard cells, preferably, at transistor level, e.g., in a SPICE transient simulation. In this example, the inverter 180 is a CMOS inverter with a PFET 180P and an NFET 180N driving a capacitive load (i.e., capacitance, C) 184. Preferably, simulation is on post-layout extracted standard cell netlists connecting the time-varying current pulse model 182 in parallel with an off transistor. In each instance one circuit transistor is held off and a pulse, modeled as a time-varying current pulse 182, is applied in parallel with the off transistor Current through a capacitor generates a voltage across the capacitor. So, in this example, the time-varying current (I_{C}) 182 is in parallel with the inverter 180, with PFET 182P off. The event simulating pulse drives the load 184, to generate a time-varying voltage (V_{SEU}), i.e., I_{C}=dV_{SEU}/dt, that the on device, 180N in this example, must recover, i.e., discharge. The result of charging from the current pulse and discharging is a single voltage pulse with a charge time determined by the current supplied in the event and the discharge time, in this example, being the time for the on device 180N to discharge. Further, since the charge originating from a particular event may completely discharge the capacitive load and continue for some period after the collision (e.g., due to the time for event originated carrier pairs to recombine to an insignificant levels) very likely, the pulse width is wider than the charge and discharge times.

Voltage responses to each modeled event for each device in each standard cell book are sampled and stored for later use, e.g., in a look up table. Thereafter, rather than generating a new voltage response (i.e., a pulse) to an event, the stored response may be retrieved and used in the fast transient simulation 144 to pre-characterize a selected cell's voltage response. So, each cell in the standard cell library is pre-characterized once, using the physics-based analytical device model 180 and current pulses (e.g., 182) modeling ionizing particles (events). Because it is quicker to retrieve a stored value than to generate the values, device level SEU analysis for an entire circuit/macro/chip is significantly simpler.

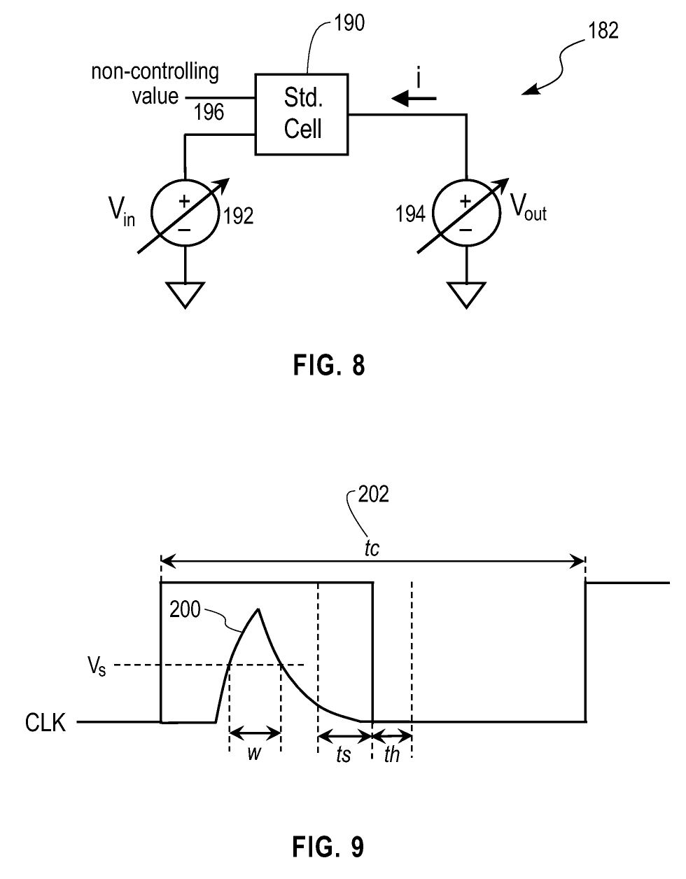

FIG. 8 shows a simple example of DC or static pre-characterization to obtain current for all bias conditions of interest on a typical standard cell 190 in circuit response pre-characterization step 144. DC pre-characterization is primarily to characterize the sink/source current at the cell output across a range of potential input and output voltage bias conditions. So in this example, the standard cell 190 has two inputs and a single output and variable input and output voltage sources (Vin, Vout) 192, 194, providing varying bias conditions. During DC pre-characterization, all unused or side inputs are set to non-controlling values, e.g., a logical zero “0” for a NAND gate or a logical one “1” for a NOR gate. The input and output voltages 192, 194 are varied (e.g., ramped up/down or set voltages at selected data points within a voltage range of interest), and the output current measured in Vout, e.g., 194 SPICE DC simulation. The measured current is a function of the input and output voltages 192, 194, I=f(Vin, Vout) that may be stored in table form for subsequent table look up. Each DC response characterizes a standard cell to provides a transfer function that is time independent, but may be used to provide a response to a time varying input that is a close facsimile to a corresponding SPICE AC simulation. Thus storing the DC response data in table(s) facilitates a very fast and accurate gate level (rather than device level) transient simulation facsimile.

FIG. 9 shows a program flow example of event generation and pulse propagation simulation, e.g., in event fast transient response analysis 146 of FIG. 3, to iteratively generate a soft error rate for each logic block or cell 1460 in the standard cell library. Based on the previously generated and collected ionizing particle physical information, radiation events are simulated at the output of each standard logic cell. So, each logic block 1460 is subjected to each modeled radiation event (e.g., from particle path analysis 142) until all events have been selected in step 1462. In step 1464 a current pulse model of an event is selected from previously stored event models, e.g., from a look up table, from particle path analysis 142, to simulate generating an event of width Δt. From the current pulse model a corresponding voltage pulse model is selected from previously stored pre-characterized event voltage pulses 1466, e.g., from a look up table generated from particle path analysis 142. In step 1468 the pre-characterized DC current (I(k)) for the logic cell at Vin(k) and Vout(k) is retrieved and in step 1470 combined with the voltage pulse model with the logic book loaded with an effective capacitive load Ceff. Given the input voltage, Vin(t), for any cell at all points time; the output voltage, Vout(t), can be iteratively computed from:

$$Vout ( 0 ) = \{ \begin{matrix}0 & if [ ( inverting\_gate \& Vin ( 0 ) VDD ) or ( non\_inverting \_gate \& Vin ( 0 ) 0 ) ] \\ VDD & if [ ( inverting\_gate \& Vin ( 0 ) 0 ) or ( non\_inverting \_gate \& Vin ( 0 ) VDD ) ]\end{matrix} \\ Vout ( k + 1 ) = Vout ( k ) - \frac{I ( k ) \cdot Δ t}{Ceff} .$$

The pulse propagates across the fan-out cone of the selected logic cell, terminating either at one or more storage element(s) 1472 or primary output(s) (PO) 1474, e.g., at a boundary or pipeline register (or is this off chip drivers?). If in step 1472 the fan-out cone terminates on a storage element, then the SER is computed 1476 for the storage element in step 1472. Otherwise, in step 1474, the fan-out cone is checked for other primary outputs and, if any remain, returning to step 1470 the event propagates through one of those other primary outputs. When the event reaches the last primary output 1474 or after computing the SER for a storage element in step 1476, returning to step 1472, if events remain unsimulated, another event is selected and cell response is generated. When in step 1472 all events have been selected, simulation is complete for the currently selected cell. Typically, this event generation and pulse propagation simulation is performed on every cell in the standard cell library or, as a standard logic cell is added, on the newly added cell.

Thus, voltage pulse propagation based on the tabular DC transfer functions for each standard cell applied to post-layout extracted cell netlists (instead of simulating a flat design) provides an accurate reflection electrical responses of all standard cells in any design. While some inaccuracy may arise from the parasitic capacitances that, normally, are not captured or considered in DC simulations, this inaccuracy is minimal. Nevertheless, in spite of this minimal inaccuracy, SEU simulations are provided with very fast runtime (requiring only a table-lookup and simple calculation) and with results that are very close to prohibitively long SPICE simulations.

It should be noted that in the above described static transient simulation, all paths are taken to be sensitized during voltage pulse propagation and logical masking effects are ignored. Also static simulation allows propagation of only one voltage pulse through a gate. To avoid any problem that might arise from re-convergent fan-outs, a conservative approach may be used, e.g., propagating the worst pulse.

When a voltage pulse reaches a storage element in step 1472, the probability of SEU in the element due to the radiation event is computed in step 1476 and added to the overall SER of the element. Whether a SEU is caused by a collision at a sensitive combinational logic node in a path terminating at a storage element further depends on various design factors. Two of those factors, electrical properties of design gates and signal flows in the design, are accurately accounted for by fast transient simulation. Other factors reduce the SER and include the storage element latching window and related timing, path logical masking effects, and the probability distribution of the radiation events to the SER of each storage element. The SER for a particular path to a storage element must be offset/reduced or derated for these other factors.

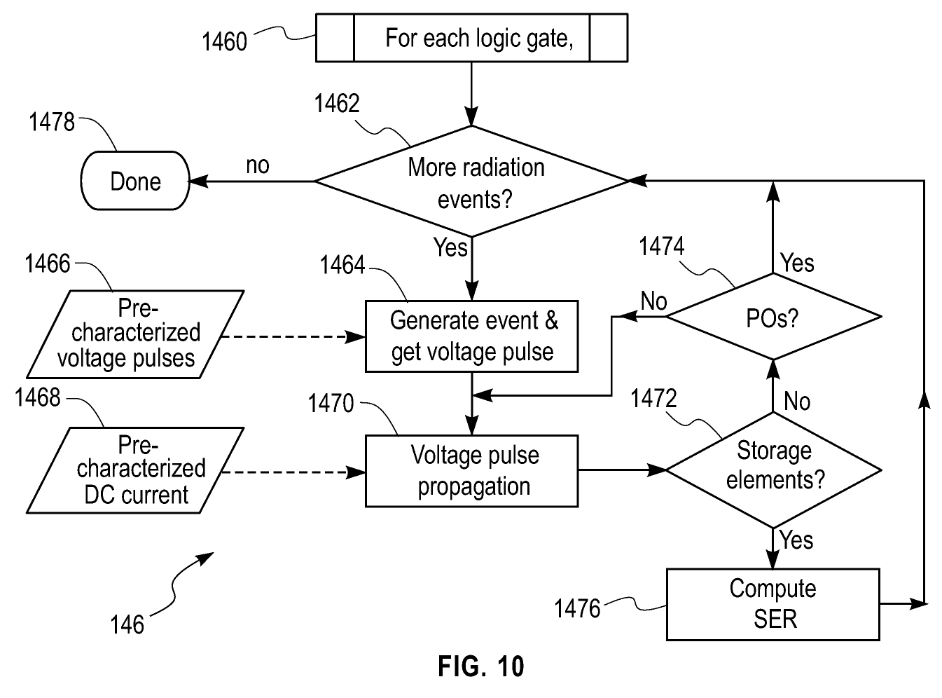

FIG. 10 shows a timing example showing an event 200 in a latching window 202. Generally, any storage element has some minimum time that an input must be valid prior to latching, known as the setup time (ts). Further, any storage element has some minimum time that an input must remain valid after to latching, known as the hold time (th). Also, there is some minimum time that the clock must remain asserted for latching an incoming input, known as the clock period (tc). If any of these required times are not met, the contents of the storage element are indeterminate. Consequently, when a voltage pulse 200 of sufficient amplitude and width reaches a storage element within the latching window of the storage element, the storage element may store a wrong logic value or enter meta-stable operation. So, representing the switching threshold of the storage element as Vₛ, and the width of the pulse at Vₛ as w, then the probability for a voltage pulse to cause an SEU in the storage element, probe, is given by:

$${prob}_{l} = \{ \begin{matrix}0 , & w = 0 \\ \frac{( w + ts + th )}{tc} , & 0 < w < ( tc - ts - th ) \\ 1 , & w \geq ( tc - ts - th )\end{matrix}$$

which may be used in determining the SER of the storage element in step 1476.

For an event to cause an upset, the event must occur at the right time and at a sensitive path (the right place). Since path sensitization is state and time dependent, and finding true sensitized paths requires significant simulation time, and so, is computationally very expensive. Further, the upset must switch states in a signal from the steady value, i.e., switch from a high to a low or a low to a high. Otherwise, an event that does not switch signal states, cannot cause an upset and is a non-event. Moreover, for an SEU to occur in a storage element due to a particle in the combinational logic, a voltage pulse (from the switched signal) must propagate through the fan-out cone from the event-source to an event-sink, e.g., a storage element or a boundary register. So, a sensitized path must exist between both the event-source and event-sink with both at the correct logic value. Previously, SER analysis provided a single probability value without input or timing information. Consequently, prior SER analysis failed to consider path sensitization.

By contrast, preferred analysis provides a reasonable estimate of both location and time dependent logical masking effects. Signal probabilities are the probabilities for a net in a design to be at a logical 0 or 1, which is determinable from the circuit description. Also, if necessary, the same signal probabilities are determined for primary inputs. By denoting the signal probability for the event-source and the event-sink to be at logic value K, as pKₛ and pKₗ, respectively, the probability of logical masking effects may be derated according to:

$${prob}_{l} = {pK}_{s} \cdot {pK}_{l} \cdot {prob}_{l}$$

$$where$$

$$K = \{ \begin{matrix}0 & if pulse glitches up \\ 1 & if pulse glitches down\end{matrix}$$

Locational or area derating is directly related to the area of the particular standard cell or circuit. For an IC having a given area (A_{T}) located in a given the radiation field being struck by an ionizing particle; a particular standard cell or circuit on the IC with an area (Aₛ); the probability of being struck may be derated according to: probₗ=Aₛ/A_{T}probₗ.

Also, since events may be caused by a variety of event particles, each radiation event has a certain associated probability. Hence for each event, the SER may be derated according to: prob₁=p(radiation_event)·probₗ.

After derating, an overall storage element SER, Pₗ, can be determined by summing the probability of all radiation events according to: Pₗ=Pₗ+probₗ ∀ radiation_events . Once an overall SER is determined, gate and/or transistor level SEU vulnerable regions can be identified and flagged. This is extremely useful for measuring and, once measured, mitigating the Logic Circuit SERs in sub-90 nm CMOS technologies.

While the invention has been described in terms of preferred embodiments, those skilled in the art will recognize that the invention can be practiced with modification within the spirit and scope of the appended claims. It is intended that all such variations and modifications fall within the scope of the appended claims. Examples and drawings are, accordingly, to be regarded as illustrative rather than restrictive.

What is claimed is:

1. A logic circuit tool for analyzing soft error sensitivities in logic, said tool comprising:
a particle generator simulating events likely to occur for a given operating environment;
a pre-characterizer providing circuit block responses to simulated said events;
a circuit response simulator providing an indication of soft error sensitivity for a circuit design; and
means for selectively modifying said design responsive to said indication.

2. A logic circuit tool as in claim 1, wherein said particle generator comprises:
a nuclear database containing models of likely event particles; and
means for simulating travel of said event particles through a semiconductor, and electron-hole pairs generated in said semiconductor.

3. A logic circuit tool as in claim 2, wherein said particle generator further comprises means for simulating a nuclear reaction to an event particle, said nuclear reaction providing a plurality of fragments.

4. A logic circuit tool as in claim 2, wherein said means for simulating travel simulates travel through layers above said semiconductor.

5. A logic circuit tool as in claim 2, wherein said particle generator further comprises an atomic database indicating ion energy ranges of said event particles.

6. A logic circuit tool as in claim 2, wherein said means for simulating travel comprises means for constructing an effective Linear Energy Transfer (LET) indicating the energy loss per unit track length for each of said event particles.

7. A logic circuit tool as in claim 1, wherein said pre-characterizer comprises:
a transient response simulator simulating a transient response to an event in a provided said circuit block, simulated transient responses being stored for simulating events by said circuit response simulator; and
a static response simulator simulating a static response to said event in said provided circuit block, simulated static responses being stored for biasing circuit blocks by said circuit response simulator responsive to simulated events.

8. A logic circuit tool as in claim 7, wherein said circuit response simulator propagates a simulated event through the fan-out cone of each circuit block in said circuit design.

9. A logic circuit tool as in claim 1, wherein said circuit response simulator further comprises an SER derater derating a soft error sensitivity indication.

10. A logic circuit tool as in claim 9, wherein said SER derater reduces an SER determined for a circuit, said SER being derated for event timing, circuit size and logic state masking.

11. A computer program product for analyzing soft error sensitivities in logic, said computer program product comprising a computer usable medium having computer readable program code thereon, said computer readable program code comprising:
computer readable program code means for storing a library of standard cells;
computer readable program code means for simulating nuclear particles colliding with a semiconductor body for a selected operating environment;
computer readable program code means for pre-characterizing each standard cell in said library of standard cells to events resulting from simulated said nuclear particles;
computer readable program code means for storing pre-characterized responses for said each standard cell to every simulated nuclear particle;
computer readable program code means for simulating a circuit response to an event in a standard cell in said circuit, and providing an indication of soft error sensitivity for said circuit; and
computer readable program code means for selectively modifying a circuit design responsive to an SER indication.

12. A computer program product as in claim 11, wherein the computer readable program code means for simulating nuclear particles comprises:
computer readable program code means for storing a nuclear database containing models of likely nuclear particles; and
computer readable program code means for simulating travel of said event particles through, and generation of electron-hole pairs in, said semiconductor body.

13. A computer program product as in claim 12, wherein the computer readable program code means for simulating nuclear particles further comprises computer readable program code means for simulating a nuclear reaction, said nuclear reaction providing a plurality of fragments.

14. A computer program product as in claim 12, wherein the computer readable program code means for simulating travel comprises computer readable program code means for simulating travel through layers above said semiconductor body.

15. A computer program product as in claim 14, wherein said layers above said semiconductor body are Back End Of the Line (BEOL) layers.

16. A computer program product as in claim 12, wherein the computer readable program code means for simulating nuclear particles further comprises computer readable program code means for storing an atomic database indicating ion energy ranges of said event particles.

17. A computer program product as in claim 11, wherein the computer readable program code means for simulating nuclear particles further comprises computer readable program code means for constructing an effective Linear Energy Transfer (LET) of each simulated nuclear particle indicating the energy loss per unit track length for each of said event particles.

18. A computer program product as in claim 11, wherein the computer readable program code means for pre-characterizing comprises:
computer readable program code means for simulating a transient response to an event in a provided said circuit block, simulated transient responses being stored for simulating events by said circuit response simulator; and
computer readable program code means for simulating a static response to said event in said provided circuit block, simulated static responses being stored for biasing circuit blocks by said circuit response simulator responsive to simulated events.

19. A computer program product as in claim 18, wherein the computer readable program code means for simulating said circuit response comprises computer readable program code means for propagating a simulated event through the fan-out cone of each circuit block in said circuit design.

20. A computer program product as in claim 18, wherein the computer readable program code means for simulating said circuit response comprises computer readable program code means for SER derating a soft error sensitivity indication.

21. A computer program product as in claim 18, wherein the computer readable program code means for SER derating comprises computer readable program code means for reducing an SER determined for said circuit for event timing, for circuit size and for logic state masking.

22. A circuit design tool for designing standard cell Integrated Circuit (IC) logic chips with a known soft error rate, said tool comprising:
a standard cell library including a plurality of logic blocks connectable into higher level logic circuits;
a particle generator simulating effects on said plurality of circuit blocks of particles likely strike said IC chip for a given operating environment;
a pre-characterizer providing responses for each of said plurality of circuit blocks to each of said particles;
a circuit response simulator simulating circuit responses in a higher level logic circuit, said circuit responses being responses in each of a respective circuit block to each of said particles, an indication of soft error sensitivity for a higher level logic circuit being provided responsive to said circuit responses; and
means for selectively modifying said a higher level logic circuit responsive to said indication.

23. A circuit design tool as in claim 22, wherein said particle generator comprises:
a nuclear database containing models of likely event particles;
an atomic database indicating ion energy ranges of said event particles;
means for simulating travel of said event particles through said IC logic chip; and
means for simulating generation of electron-hole pairs in a semiconductor below said higher level logic circuit.

24. A circuit design tool as in claim 23, wherein said particle generator further comprises means for simulating a nuclear reaction to an event particle, said nuclear reaction providing a plurality of fragments.

25. A circuit design tool as in claim 23, wherein said means for simulating travel simulates travel through layers above said semiconductor.

26. A circuit design tool as in claim 25, wherein said means for simulating travel comprises means for constructing an effective Linear Energy Transfer (LET) indicating the energy loss per unit track length for each of said event particles.

27. A circuit design tool as in claim 22, wherein said pre-characterizer comprises:
a transient response simulator simulating a transient response to an event in said each circuit block, simulated transient responses being stored for simulating events by said circuit response simulator; and
a static response simulator simulating a static response to said event in said each circuit block, simulated static responses being stored for biasing circuit blocks by said circuit response simulator responsive to simulated events.

28. A circuit design tool as in claim 27, wherein said circuit response simulator propagates a simulated event through the fan-out cone of each circuit block in said higher level logic circuit.

29. A circuit design tool as in claim 22, wherein said circuit response simulator further comprises an SER derater derating a soft error sensitivity indication.

30. A circuit design tool as in claim 29, wherein said SER derater reduces an SER determined for a circuit, said SER being derated for event timing, circuit size and logic state masking.
